(19) United States
(12) Patent Application Publication
(10) Pub. No.: US 2016/0002464 A1
(43) Pub. Date: Jan. 7, 2016

(54) CATALYST FOR ASPHALT MIXTURE

(71) Applicants: Hemando GOMEZ DE LA VEGA MOGOLLÓN, (US); Rafael Leonardo BARROETA VALERO, (US)

(72) Inventor: Rafael Leonardo BARROETA VALERO, Merida (VE)

(21) Appl. No.: 14/769,763

(22) PCT Filed: Feb. 22, 2013
(86) PCT No.: PCT/IB2013/000247

§ 371 Date: Aug. 21, 2015

(51) Int. Cl. C08L 95/00; C08K 3/04; C08K 5/053

(52) U.S. Cl. CPC C08L 95/00; C08K 5/053; C08K 3/04; C08L 2555/50; C08L 2555/60

(57) ABSTRACT

An asphalt formulation showing increased lifespan without requiring thermal conditions is disclosed. The formulation exhibits the following two properties: 1) inhibition the oxidation of its flowed components, resins and oils (aromatic and saturated) and 2) preservation of the colloidal stability of the asphaltene, inhibition of its adsorption on aggregates (pricked stone, sand) until the moment of the paving.

### TECHNICAL FIELD

### Involved Mechanisms and Phenomena

The most relevant phenomena that happen in the asphalt mixture are those of the adhesion, cohesion, ductility and, in the time, the oxidation of resins and oils, to compounds similar in its behavior to the asphaltene.

The Adhesion, talks about the capacity of the asphalt mixture to adhere to aggregates (sand and stone) in the paving mixture.

The Cohesion, is the capacity of the asphalt mixture to maintain the particles of aggregates in the finished pavement firm. The molecules that govern this phenomenon more strongly in the bitumen are asphaltene molecules, but the presence of other substances affects the properties and behavior of the asphaltenes.

The Ductility, talks about to that the asphalt mixture under a effort relatively small, but maintained in the time, does not fracture, but on the contrary is conformed to the surface, for example when the highway sinks, restituting itself its mechanical property, which this regulated by the resin content.

The most striking chemical phenomena on the asphalt mixture, have to do with the oxidation process that undergo oils and resins in the presence of environmental factors (high humidity), especially oxygen. On the matter, one of components of our catalyst (C) has as main function to neutralize the oxygenation, that it avoids aside from the oxidation of the mixture, to control the combustion and explosions of the mixture catalyzed in the containers in which it is going away to reheat.

It slows down in considerable form that the oils do not oxidize in so just a short time to resins and therefore, these to asphaltenes, that is indeed what the mixture makes that asphalt conventional (no catalyzed), becomes fragile and fracture, cracking itself.

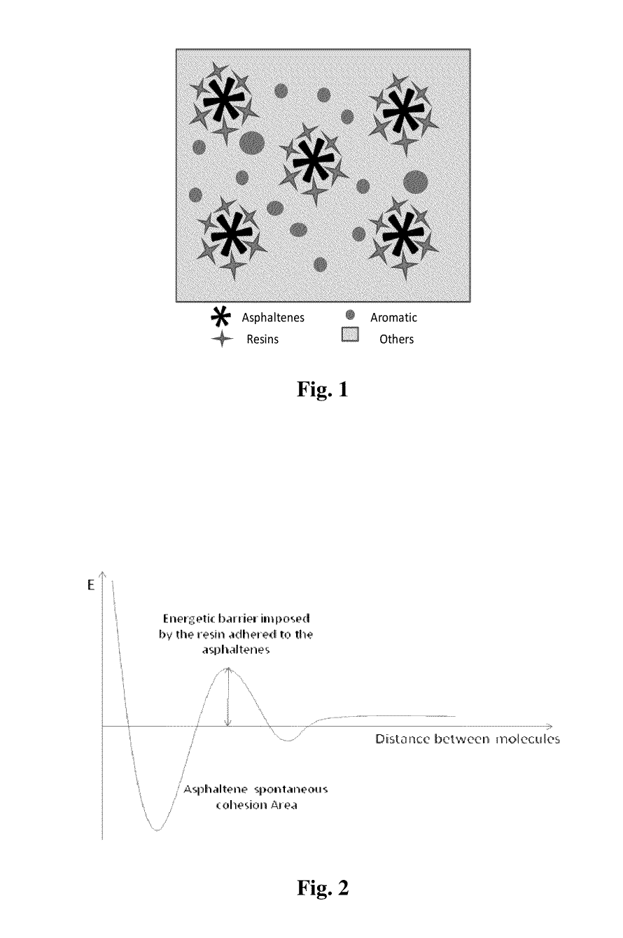

In bitumen, resins fulfill the role of dispersant agent on asphaltenes, these “solvated” to molecules and aggregates of asphaltenes covering to them and making a smooth transition between asphaltenes, “polar” compounds, and oils, non-polar compounds, inhibiting or restraining their cohesion, which inhibited to this asphalt to be used for paving (FIG. 1).

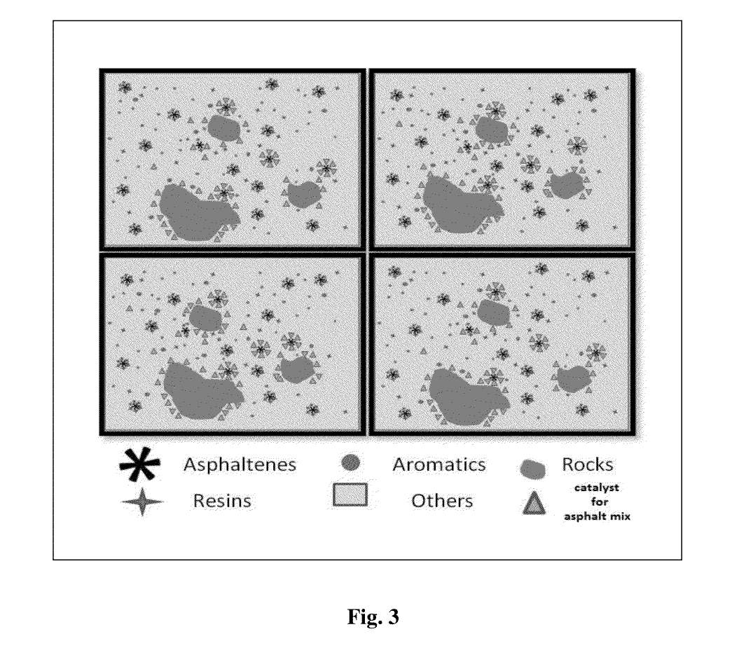

The molecules and colloidal aggregates asphaltene in bitumen are stabilized by the resin molecules that present a steric energy barrier to the intermolecular forces and inter aggregates between nanoparticles of asphaltenes . The resin adhered to the surface of asphaltene provides an energy barrier that separates both molecules; if this barrier is overcome, asphaltene molecules flocculates spontaneously soon would collapse in an aggregate strongly united, of practically irreversible way. (FIG. 2)

At the time of adding one of the aggregates, as it is the stone (material very polar) to the asphalt mixture, the system load is altered, the surface of stones becomes attractive to the asphaltenes with an energy that overcomes the barrier of resins, so reason why these adhere to the stone and then they are united to each other, with very strong connections (force of Van der Waals). In order to return to the initial state and extreme energy is required that could disarticulate the molecule before separating them; by such reason, after that asphalt has been solidified it is considered irreversible. It is indeed one of the functions of one of the components of our catalyst, like is the component (A) that debilitates these connections in cold to the maximum. To the reheated being the catalyzed asphalt mixture, the element (A) evaporates completely (it is not polluting), giving back to the mixture the property of the cohesion of resins (force of Van der Waals) for its normal hardening.

Whereas in the conventional asphalt mixture (not catalyzed) is warmed up, the kinetic energy of the same allows that adhesion or strong cohesion between its components does not take place, by a time. Nevertheless, at the time of paving, the mixture is scattered in the heat of the moment and the same is let cool, while this happens, the solvents that maintain the viscosity of mixture and dispersed asphaltenes, all of these evaporates, taking place simultaneously then the phenomena of adhesion and cohesion between the components of the asphalt mixture, resulting in an adhered and resistant pavement with visco-elastic characteristics.

The versatility of the conventional asphalt mixture, since we have referred, turns to this material into favorite in the paving. Nevertheless, the own characteristics of this, give foot to that certain phenomena (adhesion, cohesion) at irreversible an relatively high speed take place, giving a very short period of manipulation, making difficult their transfer to distant places, which is translated to an excessive increase in the costs of the operation. This difficulty is the one that resolves our catalyst (object of this request of patent), granting to the being added to the asphalt mixture, a period of life by a year or more for the reasons previously described.

### SUMMARY OF INVENTION

Asphalt Mix, and its associated or own costs, and the operations required for its application, it is now the universal material to choice for paving and repairing roads. Nevertheless, this remarkable material has some disadvantages, among the most important are the fact that its management is carried out at relatively high temperatures, because some of its components are oxidized in a few hours doing hard low ductility, which makes it unattractive, and to dilute it requires large volumes of solvents that end evaporates once paved roads, leading to environmental consequences.

One of its biggest drawbacks is that once prepared this material should be applied on roads in a relatively short time, usually less than 8-10 hours. This of course means we must have asphalt plants in the vicinity of the roads paved.

To reduce these drawbacks we developed a formulation to increase the lifespan of asphalt mixtures without requiring thermal conditions.

### DESCRIPTION OF THE PROBLEM

The advantages of conventional asphalt mixture, as far as their properties and phenomena that suffer or inhibit, does the material most widely used to pave the majority of the highways of the world. This material, nevertheless, presents a variety of disadvantages that remarkably make difficult its operations, its reduction in price, commercialization, especially exports. One of its major disadvantages is that this material once preparation and left plant, is due to apply in a relatively short time, generally of 6 to 8 hours. This by all means implies to have, in the proximities of the highways to pave, asphalt plants, machinery and specialized personnel which are due to be ready for operations, very expensive by the way.

Furthermore, having small and movable plants of asphalt is little practical, then between consecutive working lots would be great variations in its basic properties. This without telling that although the distance is the adapted one, the meteorological conditions can change suddenly, as well as the disadvantages that can appear towards transport of the mixture asphalt, mechanical flaws, among others.

### SOLUTION TO PROBLEM

In order to diminish the disadvantages previously written down that presents the conventional asphalt mixture, like it is that one becomes hardened between 6 to 8 hour from the time of departure of plant, we have developed a formulation (Catalytic of Asphalt Mixture CTL3) that allow to increase significantly the time of useful life of it catalyzed asphalt mixtures, without requiring rigorous thermal conditions, lowering the price of costs, offering a variety of operational benefits that give to the final product (CTL3) a great competitive advantage with respect to conventional asphalt formulations.

Due to the different inconvenient, we have developed a technology (object of this request of patent) that allows to use a formulated asphalt mixture so that owns ideal properties to pave highways, up to 180 days of its original preparation (it mixes conventional asphalt +catalyzed asphalt mixture), remaining in the resulting asphalt mixture, that is the catalyzed asphalt mixture, intact the physic-chemical and mechanical properties of the conventional asphalt mixture an fulfilling all the legal requirement and norms that govern this activity.

In such sense, our idea turn in developing a technology (object of this request) that aimed in two-ways: 1) that inhibited the oxidation of its flowed components, resins and oils (aromatic and saturated) and 2) that preserved the colloidal stability of the asphaltene, inhibiting its adsorption on aggregates (pricked stone, sand) until the moment of the paving and as soon as destabilized promoting its adsorption.

To this we have developed our technology through a catalyst of asphalt mixture, that consists of the mixture of 3 components (A, B, C) (see table 1) that it satisfies totally in those two-ways referred previously and other requirements that we will explain next; numerous test therefore have confirmed it to us. We are conscientious and methodologies of preparation of the catalytic object of this request of patent, as well as the aggregate used in the asphalt mixture, so that its performance can be improved and optimized.

TABLE 1
Table 1: describes to the amounts and the
effects conferred by each of the components.
Compound

| | | | | Function | |
|---|---|---|---|---|---|
| | Quantity/ | | Charac- | Hypothesis | Hypothesis |
| Compound | 250 Kg | | teristics | Initial | sugared |
| (A) | 4 | L | Liquid | thickener | (inhibits- |
| GLYCERINE | | | (Solution | | Induced |
| | | | at 70%) | | Physico- |
| | | | | | chemical |
| | | | | | interactions) |
| (B) | 8 | L | Liquid | It | Transportation, |
| BITUMEN | | | | supersedes | solvent, |
| | | | | the | dispersant |
| | | | | evaporated | |
| (C) | 2 | Kg | Solid, Cp: | consistency | |
| COAKING | | | 11.000 y | Provides | |
| COAL | | | 12.000 BTU | Thermal | |
| (CARBON) | | | | Quality | |

### ADVANTAGEOUS EFFECTS OF INVENTION

Next some test are indicated that could be realized in order to support to the advantages provide by the product object of patent request. The same should be take place so much to the conventional asphalt mixture as to the formulation of catalyst CTL3.

Penetration: This test measures the consistency or stiffness (viscosity) of the asphalts, it consist in leaving to a needle prototype, placed to the greatest lower bound of a bar that slide freely within a cylindrical support, maintained vertical, and penetrate in an a sample of asphalt mixture, previously cooled to 25 centigrade degrees. In the least upper bound of the bar were placed a weight, first one of 100 grams and another test with 150 grams.

Ductility: consist in observe the length reached, without breaking itself, of a sample of both kind of asphalt mixture, conventional and catalyzed, submerged in a maintained water bath to 25 centigrade degrees, stretch it to a fixed rate of 5 centimeters per minute, by means of an apparatus especially designed for this test.

Softening point: by measuring the temperature to which the consistency of our catalyzed asphalt mixture was so, that a steel sphere happening through a bronze ring, in whose interior there was placed the sample of asphalt.

Viscosity: a metal ball is placed on top of a cylindrical tube filled with asphalt mixture, to test flood at a certain temperature, and let it drop, so that this ball falls by gravity. The time it takes to move a certain distance within the tube is the measurement of the viscosity of the asphalt.

Mechanical resistance: a ball of an average pound is dropped on a sample of asphalt mixture. The height where the sample fractured is the measurement of the mechanical resistance to the fracture, to the high and precise effort, in instantaneous form.

Note: it is recommendable to operate the asphalt at temperatures below 300° C., below the flash point.

Chromatographic test: a solution of asphalt is “titrated” in a solvent (n-heptano) that dissolve the asphaltenes, while carrying out this procedure takes a drop and added to a filter paper and record the volume in which it appears a chromatographic spot that shows have destabilized asphaltenes. To Higher volume of n-heptane, more stabilizing is the treatment. This test gives an idea of how much a given formulation protects asphalt colloidal stability.

Residue content: asphalt is dissolved in carbon tetrachloride, toluene or benzene, solvents that dissolve all components of the asphalt and the remainder is weighed and gives an idea of not asphalt components (inorganic and metals).

Content of asphaltenes, resins and oils: dissolve the crude oil in an excess of naphtha 86° API or in n-heptane, the precipitated residue is filtered, dried and weighed. The weight is the content of asphaltenes, the difference between the sample weight of asphalt and asphaltenes is the content of resins and oils.

Oxidation of resins and oils: It is carried out a titulation over an asphalt-solvent solution and it is determined the concentration of asphaltenes. By doing this test to samples of asphalts mixtures under different treatments at different times after to have been prepared, we can get an idea about the degree of oxidation of the asphalt by correlating it with the content of asphaltenes. This would measure that both protects the asphalt mixtures of the oxidation process with certain formulation.

Test Realized with our Asphalt Mixture Catalyst:
1. Preparation of several buckets with catalyst with the substances (A, B, C) in the proportions written down in table 1, with sufficient amounts to be added to a barrel of 250 Kg of conventional asphalt mixture. See dosages in table 1.
2. Added to each barrel (8 units) of 250 kg each, mixed asphalt from plant, the content of each bucket, previously warmed up to 80 centigrade degrees.
3. Without removing, proceed to seal the 8 barrels in hermetic from to avoid the water entrance.
4. Three (3) month later, the 8 catalyzed barrels were open, being the content of the catalyzed mixture with an acceptable viscosity.
5. Reheat the barrel of the catalyzed asphalt mixture up to 135 centigrade degrees, at that temperature we drained the content of the barrel in a prepared zone to pave.
6. Then proceed to extend the catalyzed asphalt mixture, verifying with a rod thermometer that was properly to about 118 centigrade degrees in the finisher to form and prepare the area to place the material in the asphalt folder, applying to the asphalt mixture catalyzed a light roller compactor of 10 tons of weight in the prepared area and soon applied a heavy roller but until arrived at the suitable degree of compaction. The test were made to determine the index of permeability of the folder that was of 7,98%. Later made the respective seals with the proper procedures in the conventional mixture to avoid that introduce the water in the folder, to protect it of the wearing down and to avoid the sliding phenomena, skid or “acuaplaneo”.
7. 24 hour later, the paved one with the catalyzed asphalt mixture displayed the conditions more than acceptable of hardening, compaction, resistance and elasticity of the conventional mixture and in the ranks of the exigencies and controls demanded by the competent organisms.
8. Seven month (7) later other 2 barrels were opened and the catalyzed asphalt mixture was practically equal to the 4 barrels opened in the first 3 months, coming to scatter it in the site preparation for it. Also the result was satisfactory.
9. Twenty nine (29) month later the 2 remaining barrels were opened and the catalyzed asphalt mixture was practically in the same conditions of the 6 previous barrels.
Final Observation: we are at this moment realizing the pertinent studies on a large scales to establish a methodology or industrial design for the incorporation of the catalyst to the asphalt mixture industrialist, as well as the casting and packaging, that will be another request, that is the one of design of industrial process.

### BRIEF DESCRIPTION OF DRAWINGS

1) Element B, resins covers the molecules of asphaltene inhibiting the interaction among them, and with this avoiding the cohesion of the molecules;

2) Asphalt mixture, when introducing the stones (highly polar substances) the loads of the system are altered and spontaneously the molecules of asphaltenes being drawn into its surface, breaking the energy barrier imposed by the resins, until they are crowded together and they united with enormous forces that require very high levels of energy to return to their initial state (so elevated that they consider an irreversible process). The aggregate (A) of our catalyst as we explained already, neutralizes in cold this cohesive force, allowing that when evaporating (A) in the catalyzed mixture, this recovers its property (force of Van der Waals) (FIG. 3)

Compound (A) inhibits the interaction between the asphaltenes and the aggregates of the asphalt mixture, allowing that the mixture stays by viscous longer time. Furthermore, that compound C in the catalyst, avoids the oxidation of compounds of the asphalt mixture. In order to support this hypothesis, they were taken with the involved materials, (where it proved the change in resulting viscosity and post evaluation of aggregation of the asphaltenes to different concentrations of the CTL3 resin, including the material without resin).

1.-6. (canceled)

7. A mixture, comprising:
glycerine;
bitumen; and
coking coal.

8. The mixture of claim 7, wherein the glycerine is a 70% liquid solution.

9. The mixture of claim 7, wherein the coking coal is a solid at constant pressure with a heat supplied value between 11,000 and 12,000 Btu.

10. The mixture of claim 7, wherein the mixture contains a ratio of 4 L of the glycerine to 8 L of the bitumen to 2 Kg of the coking coal.

11. A mixture, comprising:
glycerine;
bitumen;
coking coal; and
conventional asphalt mixture.

12. The mixture of claim 11, wherein the glycerine is a 70% liquid solution.

13. The mixture of claim 11, wherein the coking coal is a solid at constant pressure with a heat supplied value between 11,000 and 12,000 Btu.

14. The mixture of claim 11, wherein there is 4 L of glycerine, 8 L of bitumen, 2 Kg of coking coal, and 250 Kg of conventional asphalt mixture.

15. The mixture of claim 11, wherein the mixture contains a ratio of 4 L of the glycerine to 8 L of the bitumen to 2 Kg of the coking coal to 250 Kg of the conventional asphalt mixture.

16. A method, comprising:
Preparing a mixture by combining glycerine, bitumen, and coking coal;
Adding the mixture of glycerine, bitumen, and coking coal to conventional asphalt mixture and combining to create a catalytic mixture; and
Creating a hermetic seal around the catalytic mixture.

17. The method of claim 16, wherein the glycerine is a 70% liquid solution.

18. The method of claim 16, wherein the coking coal is a solid at constant pressure with a heat supplied value between 11,000 and 12,000 Btu.

19. The method of claim 16, wherein the catalytic mixture contains a ratio of 4 L of glycerine to 8 L of bitumen to 2 Kg of coking coal to 250 Kg of conventional asphalt mixture.

20. The method of claim 16, wherein the conventional asphalt mixture is heated to 80° C. before the mixture of glycerine, bitumen, and coking coal is added.
